(19) United States
(12) Patent Application Publication
(10) Pub. No.: US 2007/0243397 A1
(43) Pub. Date: Oct. 18, 2007

(54) Chromium(VI)-free, aqueous acidic chromium(III) conversion solutions

(76) Inventors: Robert J. Ludwig, Brunswick, OH (US); Andrew C. Recker, Garfield Heights, OH (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/405,315

(22) Filed: Apr. 17, 2006

(51) Int. Cl. C23C 22/24; B32B 15/04

(52) U.S. Cl. 428/472.1; 148/267

(57) ABSTRACT

An essentially chromium(VI)-free, chromium(III)-containing corrosion resistant conversion solution, or layer thereof for treating metals such as zinc, zinc alloy, aluminum, or aluminum alloy substrates. The conversion solution, is substantially free of chromium(III)-chelates, is capable of producing thick conversion films even at low temperatures, has good corrosion resistance, and is self healing with regard to scratches and the like.

### FIELD OF THE INVENTION

The present invention relates to an acidic solution, and a concentrate, for forming a chromium(VI)-free, chromium(III)-containing corrosion resistant conversion layer substantially free of chromium(III) chelates on zinc, zinc alloy, aluminum, or aluminum alloy substrates, and a method for forming a relatively thick chromium(VI)-free, chromium(III)-containing corrosion resistant conversion layer.

### BACKGROUND OF THE INVENTION

The process of forming or producing chromium(III) containing layers or films over a substrate is called passivating or chromating. Chromating or passivating a substrate involves contacting the substrate with the conversion or passivating solution for a time sufficient to allow a chemical process to take place on the surface of the substrate. This chemical process is known as passivation, and it is during this time that a chromate conversion film is formed. As chromium-containing conversion films have evolved from the earliest forms using chromium(VI) ions to the more recent introductions of chromium(VI)-free, chromium(III)-complexes, there have been numerous improvements in the processing solutions. These improvements have generally resulted in better visual appearance, and higher corrosion protection.

The visual appearance of these chromium(VI)-free, chromium(III)-containing processes, on zinc or zinc alloy as well as aluminum or aluminum alloy substrates, proves to be one of the most relevant characteristics associated with whether or not a chromium(III) film will be commercially acceptable. For all practical purposes, the appearance must be bright and clear with very distinct color patterns and the film must be adherent to the substrate and not easily removed as by wiping. Any imperfections, such as cloudiness, or loss of adhesion would not be considered an acceptable finish.

As with chromium(VI)-containing conversion films, the thickness of the layer is relevant when determining the salt spray protection provided by the chromate film. In general, the thicker the chromate(III) film, the more protection provided.

Generally, the thinnest films formed are clear or slightly bluish in color. As the film thickness grows, there is a transformation from blue to pink/red iridescence to eventually to a greenish iridescent color. All of these conversion films are iridescent and not a single hue with the exception of the thinnest blue films. The iridescent colors exhibit a “rainbow” effect depending on the angle at which the conversion film is viewed.

U.S. Pat. No. 6,287,704 and U.S. Pat. No. 6,946,201 both reveal a method for creating a conversion film that will reportedly provide chromium(III)-containing films with an iridescent appearance. These patents relate to processes for obtaining conversion films by utilizing chromium(III)-chelate ligand chemistry that regulates film formation during processing. This type of chemistry is capable of producing said conversion films but only at elevated temperatures, more preferably above 140° F. (60° C.).

Chromium(III)-chelate ligand chemistry is also utilized in U.S. Pat. No. 6,719,852, and U.S. Pat. No. 6,858,098. The use of trivalent chromium and oxalic acid in specific molar ratios produces conversion films that reportedly provide corrosion protection. Chromium(IIII)-oxalate chelation is necessary for this method to take place.

The use of chelators in order to create the chromium(III)-chelate complexes can cause serious problems during the waste treatment of these solutions. Having various chelators present in the waste stream, such as the common dicarboxylic acids in use, like malonic and oxalic acid, creates difficulty in removing dissolved metallics prior to effluent discharge. This causes a need for additional equipment and expense to aid in dissolved metal removal from the effluent. Without additional equipment the waste stream may contain levels of dissolved metallics higher than is allowable by environmental laws.

U.S. Pat. No. 4,263,059, U.S. Pat. No. 4,578,122, and U.S. Pat. No. 7,029,541, provide for conversion solutions that result in a blue hued layer. The films produced are thin, provide minimal corrosion protection, and do not provide a barrier to post treatment handling that can result in scratching and marring of the surface of the finished work. Any voids or imperfections in these films will result in premature corrosion of the finished article.

### SUMMARY OF THE INVENTION

The invention relates to thick chromium(VI)-free, chromium(VI)-containing corrosion resistant conversion solutions and layers derived therefrom, substantially free of chromium(III)-chelates.

The corrosion resistant conversion film can be applied to zinc or zinc alloy as well as to aluminum or aluminum alloy substrates at temperatures as low as 40° F. (4° C.). The corrosion resistant conversion film provides extended corrosion protection over zinc, a zinc alloy, aluminum, or an aluminum alloy substrate even if the surface is scratched and marred due to post process handling.

In one aspect of the invention, an aqueous acidic conversion solution is provided, comprising from about 0.5 to about 130 g/L of said conversion solution of a chromium(III) ion; from about 1 to about 100 g/L of said conversion solution of one or more of a non-halide salt anion; from about 1 to about 35 g/L of said conversion solution of one or more mono carboxylic acids having from 1 to about 10 carbon atoms; optionally, from about 0.1 to about 10 g/L of said conversion solution of one or more non-chromium metal ions comprising Groups 1, 2, 4, 5, 6, 7, 8, 9, 10, 11, 12, 13, or 14, of the Period Table; optionally from about 0.1 to about 30 g/L of said conversion solution of one or more halide ions; said conversion solution being substantially free of any chromium(VI) compounds, and wherein said conversion solution is substantially free of chromium(III) chelate.

In a further aspect of the invention, a process for applying a conversion layer to a metal substrate comprises the steps of: preparing a conversion solution comprising: from about 0.5 to about 130 g/L of a chromium(III) ion; from about 1 to about 100 g/L of said conversion solution of one or more of a non-halide salt anion; from about 1 to about 35 g/L of said conversion solution of one or more mono carboxylic acids having from 1 to about 10 carbon atoms; optionally, from about 0.1 to about 10 g/L of said conversion solution of one or more non-chromium metal ions comprising Groups 1, 2, 4, 5, 6, 7, 8, 9, 10, 11, 12, 13, or 14, of the Period Table; optionally from about 0.1 to about 30 g/L of said conversion solution of one or more halide ions; said conversion solution being substantially free of any chromium(VI) compounds; and wherein said conversion solution is substantially free of chromium(III) chelate; and applying said conversion solution to said metal substrate to form a treated article.

### DETAILED DESCRIPTION OF THE INVENTION

The conversion solutions of the present invention comprise one or more chromium(III)-ions, one or more non-halide salt anions, one or more non-chelating monocarboxylic acids, optionally one or more non-chromium metal cations, and optionally one or more halide anions. Preferably the conversion solution is substantially free of chromium(VI) ions.

The aqueous acidic conversion solutions of the present invention contain different ions therein as in the form of anions, cations, and the like. Such ions are derived from various compounds which can contain only one ion or a plurality of the different ions that are required in the conversion solutions of the present invention. Thus, various compounds are set forth with regard to supplying one ion such as a non-halide salt anion and also another ion such as a non-chromium metal ion. Regardless of whether one or more types of ions (e.g. Cr⁺³) are derived from a specific compound (e.g. (NO₃)₃), the listed weights of the specific type of ion (e.g. Cr⁺³) refer only to the specific ion portion of a particular compound (and not to the total weight of the entire compound), based upon the total weight of the conversion solution.

The one or more chromium(III)-ions can be derived from, but not limited to, chromium compounds, such as the chromium(III) salts of nitrate, sulfate, halide, acetate, and phosphate, chromic(III) oxide, and chrome(III) alum. Chromium(III)-ions can also be derived from reduction processes with chromium(VI), usually chromium(VI) trioxide, or a sodium bichromate source, and a reducing agent in ratios known to the art and to the literature to ensure complete chrome(VI) reduction to chromium(III) ions.

The one or more chromium(III)-ions per se are present in an amount of from about 0.5 g/L up to about 130 g/L. Desirably, the chromium(III)-ions are present in amounts ranging from about 2.0 g/L to about 50 g/L, more preferably from about 3.0 g/L to about 20 g/L of conversion solution.

The one or more non-halide anions utilized in the present invention are typically chosen from nitrate, sulfate, phosphate, di- or tri-phosphate, and acetate anions. Such anions can be derived from salts of Groups 1, 2, and 4 through 13 metals of the Periodic Table such as the alkali metal series, e.g. sodium or potassium, as sodium nitrate, sodium sulfate, potassium nitrate, and potassium sulfate, also alkaline earth metals from Group 2, such as magnesium or calcium, and the like. The salts can also be chosen from ammonium compounds such as ammonium nitrate, ammonium sulfate, or ammonium phosphate, as well as from cobalt nitrate, cobalt sulfate, cobalt phosphate, sodium mono-, or tri-phosphate, nickel sulfate, nickel acetate, or zirconyl nitrate. Anions are utilized because of their ability to activate the hydrated chromium(III) ions and to initiate the passivation of the substrate surface.

The amount of the one or more non-halide salt anions such as nitrate, sulfate, and phosphate anions, can vary greatly in their concentrations. It has been found that the combination of nitrate, sulfate, and phosphate anions has proven to be effective in the development of the chromium(III) film. The amount of the total anions is from about 1 g/L to about 100 g/L, desirably from about 5 g/L to about 50 g/L, and preferably from about 15 g/L to about 40 g/L of conversion solution.

An important aspect of the present invention is the utilization of monocarboxylic acids because of their buffering properties in the conversion solution during the layer formation which helps to form an ordered chromium(III)-ion containing layer. An added advantage of using monocarboxylic acids is that they do not form chromium(III)-chelation products in the conversion solution. As noted above, chromium(III)-chelated complexes are difficult to remove from the solution prior to effluent discharge and hence can create serious problem with regard to waste treatment. The chelates not only bind with chromium(III) ions but also, any other metal ions available in the waste stream. Thus, the present invention is considered to be environmentally friendly.

The monocarboxylic acids contain from 1 to about 10 carbon atoms and preferably from 1 to about 4 or 5 carbon atoms. Examples include formic, acetic, propionic, butanoic, or valeric acid or salts thereof. Higher molecular weight acids can be acceptable, however, as the alkyl chain increases in length, the odor of the monocarboxylic acid becomes more rancid and the acid loses its solubility in the solution. Preferred monocarboxylic acids are formic, acetic, and propionic acid, or salts thereof, or combinations thereof.

The monocarboxylic acid of the present invention can be present in amounts from about 1 g/L to about 35 g/L, desirably from about 2.0 g/L to about 25 g/L, and preferably from about 2.5 g/L to about 20 g/L of conversion solution.

The optional, one or more non-chromium metal ions (cations) can be chosen from, but not limited to, the metals of Groups 1, 2, and 4 through 14. Desired metals are chosen from iron, cobalt, nickel, molybdenum, manganese, aluminum, lanthanum, cerium, zirconium, silver, silicon, sodium, potassium, copper, vanadium, gallium, and titanium. Preferred metals include sodium potassium, iron, cobalt, nickel, molybdenum, vanadium, titanium, or zirconium, and combinations thereof. Such non-chromium cations are derived from metal per se or various salts such as those listed with respect to anionic ion containing salts. Metal ions are utilized to help produce a more dense conversion film as well as to alter the appearance of the conversion film on the substrate.

The present invention utilizes the additional one or more non-chromium metal ions in amounts that range from about 0.1 g/L to about 10 g/L, preferably from about 1 g/L to about 7.5 g/L of conversion solution.

The use of one or more halide ions such as fluoride, chloride, or bromide, (anionic) are optional but often desired because the presence of halide ions can impart additional conversion film hardness. Desired halide salts include sodium fluoride, sodium chloride, ammonium bifluoride, ammonium chloride, sodium bromide, ammonium bromide, potassium chloride, potassium bromide, chromium(III)-chloride, cobalt chloride, nickel chloride, zirconyl chloride. Preferred halide salts include sodium chloride, sodium fluoride, ammonium chloride, ammonium bifluoride, chromium(III)-chloride, cobalt chloride, and nickel chloride. Preferred halide is fluoride but chloride may be substituted where regulations restrict the use of fluoride.

The preferred sources of halide are introduced as ionizable halides, but may also include compounds with halide atoms covalently bonded to other atoms, for example, polyfluorinated materials, such as polytetrafluoroethylene, tetrafluoropropionic acid, or salts thereof.

The optional halide ion can be present in an amount from about 0.1 g/L to about 30 g/L. When present, the halide ion is desirably utilized in an amount from about 0.5 g/L to about 10 g/L and preferably from about 0.75 to about 5.0 g/L of conversion solution.

The conversion solutions of the present invention contain the above amounts of the various ion components and any other desired additives with the remaining amount being water, or other solvent, to form a liter of solution. The solution of the present invention can operate at various pH ranges such as from about 1.0 to about 4.5, and preferably from about 1.8 to about 3.4. The operating window of this invention is generally wider than traditional chromate conversion coatings. This invention offers greater flexibility and tolerances during line operation and is much more forgiving to fluctuations in pH without affecting appearance and performance of the conversion layer. In addition, the operating or application temperature is from about 40° F. (4° C.) to about 135° F. (56° C.) or to about 140° F. (60° C.), desirably from about 60° F. (16° C.) to about 104° F. (40° C.), preferably from about 65° F. (18° C.) to about 90° F. (32° C.), or any combination thereof. Lower temperatures are advantageous due to lower energy usage resulting in lower energy and heating costs for operating the conversion solutions.

In order to produce an acceptable conversion film using the present invention, the processing time, where the substrate is exposed to and in contact with the conversion solution and dried, is generally from about 10 to about 240 seconds, desirably from about 30 to about 120 seconds, more preferably from about 45 to about 90 seconds. Naturally, shorter or longer times can be utilized.

The substrates of the present invention are in the form of metal or metal coatings, as on steel or iron infrastructure, and are desirably aluminum or aluminum alloy substrates and preferably zinc or zinc alloy substrates. Examples of zinc alloy substrates include zinc/nickel (7-14% Ni), zinc/iron (0.2-1.0% Fe), or zinc/cobalt (0.2-1.5% Fe), or zinc/cobalt (0.2-1.5% Co).

The processes by which the aluminum or aluminum alloy substrates or the zinc or zinc alloy substrates are contacted with the solution of the present invention include, but are not limited to spraying, immersion, or wiping, and the like. It is common practice to use immersion as the preferred method of applying the solution to the substrate in order to achieve the desired conversion film results. However, spray techniques, which are becoming more common in the industrial setting, can also be used to achieve desired results.

The present invention can also comprise additional conventional additives or components such as water soluble silicates, colloidal silicas, surfactants, dispersants, dyes, pigments such as carbon black, organic polymers, colloidal waxes, fragrances or flavors, and phosphate ions. Such water soluble or bath compatible compounds include, but are not limited to, colloidal silicas, such as the Ludox® line available from I.E. DuPont of Wilmington, Del., or the Nalco® line available from Nalco Company of Naperville, Ill. and include Ludox® HS40, Ludox TMA, Ludox® AM, Nalco® 1034A, Nalco® 1060, Nalco®) 2327, and the like. Also, acid stable dyes or pigments such as azo, diazo, or mordant dyes can be utilized. These additives can impart additional properties to the conversion film, such as heat resistance or color variations and may be desired for certain applications.

In addition to the conversion layer that is formed, it is also noted that the chromium(III) conversion layer can be further coated with one or more film forming solutions in order to provide an additional protective topcoat film over the conversion layer or to alter its appearance. Typical films include various silicates, waxes, colloidal silicas, dyes, polymers such as urethanes and acrylics, silanes, oils, additional chromium(III)-containing coatings, or combinations thereof. Typical of the types of film forming solutions are soluble silicates, such as sodium, potassium, and lithium salts. Included as soluble silicates are solutions from PQ Corporation of Valley Forge, Pa. which include N, E, K, Kasil® 1, or Kasil® 6. These top-coating films create an additional barrier of protection over the conversion film or can change the appearance of the finished articles.

The operating bath can be conveniently prepared by employing a concentrate containing the active constituents that conveniently can be transported or stored until a desired end use application where upon prior to conversion, the concentrate is diluted, preferably with water to form a relatively diluted conversion solution having necessary amounts of the various components therein. Concentrated solutions generally contain by weight from about 3 to about 30 times more (this would equal a 3.3-33% v/v solution) grams and desirably from about 5 to about 20 times more (5-20% v/v) grams of all of the various above noted ion components per liter of aqueous conversion solution. Alternatively, replenishment of the bath on a continuous or intermittent basis can be achieved employing a concentrate of the active constituents which is added separately to the operating bath.

The conversion solutions of the present invention can be utilized to coat numerous zinc, zinc alloy, aluminum, or aluminum alloy substrates with regard to a vast number of different uses. End uses include automotive articles such as stampings; brake components such as brake lines, calipers, pads, or rotors; hydraulic couplings; transmission, engine, and steering components; clips; cylinders; rivets; fasteners; or oil filter housings; and the like. Other end uses include barrel plated articles such as fasteners, washers, clamps, nuts, stampings, bar steel, fittings, springs, and the like. Other end uses include rack plated articles such as computer chassis, refrigerator brackets and shelving, electrical motor mounts, speaker grills, large/heavy fasteners or stampings, oil filter housings, springs, tubing, clips, and the like. Still other end uses include general manufacturing and/or industrial components such as electrical boxes, motor housings, air conditioning guards, heat exchangers, small engine components, brackets, nails, garage door rollers or pulleys, plumbing fasteners or brackets, and the like. Another class of end uses include various consumer components such as door hinges, refrigerator shelving, compressor components, fasteners, shopping carts, lawn and garden tools and equipment, appliance clamps and stampings, door latches, audio/video components, furniture components, drawer slides, and the like.

The conversion solutions and coatings of the present invention have several advantages. The solutions of the present invention are substantially free and preferably free of chromium(VI)-ions. By substantially free it is meant that the solution contains at most only trace amounts of chromium(VI)-ions that the presence of these ions will be 10 mg/L or less, desirably 1 mg/L or less, and preferably less than the detectable limits on acceptable test methods for chromium(VI) in the finished layer, such as the GMW 3034 (April 2001) (0.01 μg/cm² or less) or the ISO 3613 (1982 Aug. 01) (0.005 μg/cm² or less) Chrome(VI) Tests, and will generally have no adverse environmental impact. These tests are well known to the art and to the literature. Most preferably, the invention contains no chromium(VI)-ions. The solutions of the present invention are also substantially free of chromium(lil)-chelants. By substantially free it is meant that the chelants are desirably present at concentrations of 0.25 mole or less of chelant per one (1) mole of chromium(III)-ions. Preferably the ratio of chelant to chromium(III)-ions is 0.10 mole or less: 1 mole, more preferably 0.05 or less mole: 1 mole. As noted above, a conversion solution is desirably applied at low or ambient temperatures which are below the heretofore commonly applied temperatures of at least about 140° F. and higher. Coating layers formed from the conversion solutions of the present invention have good corrosion resistance with regard to salt spray test. For example, using ASTM B-117 or ISO 9227 standards, coated articles are tested for signs of first white corrosion (FWC) or first red rust (FRR). The visual onset of these forms of corrosion indicates the limits of the conversion film. Due to the important corrosion protection afforded by the coating layers of this invention, FWC is used to determine the conversion coating effectiveness. Conversion coatings or films can readily be applied having thicknesses of from about 60 to about 750 nanometers or more, desirably from about 80 to about 600 nanometers and preferably from about 100 to about 500 nanometers which result in corrosion resistant values according to ASTM B-117 of at least about 80 hours, desirably at least about 120 hours, and preferably at least about 180 hours to first white corrosion.

In order to demonstrate the ability of the conversion film to provide corrosion protection even if damaged by scratching or marring the following test was developed. Using a single blade razor, one or two cuts are made in the conversion film of a freshly coated zinc plated test piece. Enough pressure was applied to allow the razor blade to penetrate completely through the conversion film, into the electroplated zinc layer, and in some cases down to the steel substrate itself. If two cuts are used, then the cuts should intersect at a 90° (degree) angle to each other. After the cuts are made, the test piece is placed in a dry area and allowed to cure for 24-48 hours. The test piece(s) are then placed in the salt spray chamber according ASTM B-117 and monitored for the onset of white corrosion product along the cut edges. The ability of the conversion film to continue to provide corrosion protection when compromised by scratches has often been referred to as a “self-healing” effect. Self-healing chromium(III) conversion films of this invention provide substantially better corrosion protection versus traditional chromium(III) conversion films at the cut surfaces. Cut surfaces are used to mimic the rough handling typically seen with production pieces during shipment and transport. The self-healing effect has previously only been associated with chromium(VI)-containing conversion films. The conversion film formed through this invention is the first known self-healing film based on chromium(III)-ions. See Table #2 for results.

In order to further illustrate the present invention, the following examples are provided. It will be understood that the examples are provided for illustrative purposes and are not intended to be limiting of the scope of the invention as herein disclosed and as set forth in the claims.

### EXAMPLES

In each of the following examples, the testing procedure was the same. Small to moderate sized steel parts were bright zinc coated using a barrel application in an acid chloride zinc electroplating process (Zn—27 g/L, Cl—136 g/L, pH 5.85, temp. 80° F.) to obtain a minimum of 8 microns of plated zinc over the steel. The Extreme 110 zinc brightening additives from Columbia Chemical Corp. (Brunswick, Ohio) were included in the plating bath to provide uniform brightness and even plate throughout all the examples. Immediately after plating, the parts were thoroughly rinsed in clean water, dipped for 2-4 seconds in a 0.25 to 0.5% mild nitric acid solution then immersed in the aqueous conversion solution of the present invention for 60 seconds at various temperatures ranging from 47° F. to 80° F. (8° C. to 26° C.). Parts were then rinsed in clean water for 15-25 seconds and followed by warm air drying.

After drying, the parts were allowed to cure at ambient temperature (68° F. to 75° F.) for 48 hours. After cure the parts were evaluated for appearance, salt spray performance, and “self-healing” ability.

Formulations of conversion solutions of the present invention and comparative examples are set forth in Table 1.

TABLE 1
Working Solutions

| | Examples (1) | | | | | | | |
|---|---|---|---|---|---|---|---|---|
| | | | | | | | Comparative | |
| | 1 | | | | | | Examples | |
| | (Control) | 2 | 3 | 4 | 5 | 6 | 7 | 8 |
| | grams/L | grams/L | grams/L | grams/L | grams/L | grams/L | grams/L | grams/L |
| Chromium III ions (2) | 4.37 | 4.37 | 4.37 | 4.37 | 5.98 | 4.37 | 4.37 | 4.37 |
| NO₃⁻ ions (3) | 22.18 | 22.18 | 22.18 | 22.18 | 28.88 | 22.18 | 22.18 | 22.18 |
| SO₄⁻² ions (3) | 3.51 | 3.51 | 5.11 | 5.11 | 5.28 | 4.60 | 3.06 | 3.06 |
| Non-halide salt anions (total) | 25.69 | 25.69 | 27.29 | 27.29 | 34.16 | 26.78 | 25.24 | 25.24 |
| Co⁺² ions (4) | 0.63 | 0.63 | 1.89 | 1.86 | 2.00 | 1.58 | 0.63 | 0.63 |
| Non-Chrome Metal ions (total) | 4.25 | 4.25 | 5.30 | 5.30 | 5.76 | 4.99 | 4.04 | 4.04 |
| F⁻ ions (5) | 1.86 | 1.86 | 1.86 | 1.86 | 1.33 | 0.00 | 1.86 | 1.86 |
| Glacial Acetic Acid | 0.00 | 0.00 | 10.00 | 10.00 | 0.00 | 2.70 | 0.00 | 0.00 |
| Propionic Acid | 0.00 | 15.00 | 0.00 | 0.00 | 10.00 | 3.50 | 0.00 | 0.00 |
| Malonic Acid | 0.00 | 0.00 | 0.00 | 0.00 | 0.00 | 0.00 | 15.00 | 0.00 |
| Oxalic Acid | 0.00 | 0.00 | 0.00 | 0.00 | 0.00 | 0.00 | 0.00 | 15.00 |
| pH (adjusted with HNO₃, or NaOH) | 2.3 | 2.3 | 2.3 | 2.3 | 2.2 | 2.4 | 2.3 | 2.4 |
| Temperature ° C. (° F.) | 24 (75) | 24 (75) | 24 (75) | 7 (45) | 24 (75) | 24 (75) | 24 (75) | 24 (75) |
| Processing time - seconds | 60 | 60 | 60 | 90 | 60 | 75 | 60 | 60 |
| Appearance (color/clarity) | slight | green | green- | pink- | pink- | yellow- | slight | slight |
| | blue | slight | pink | green | green | pink- | yellow- | yellow |
| | iridescent | iridescnet | iridescent | iridescent | iridescent | green | blue clear | clear |
| | | | | | | iridescent | | |
| Thickness (nm) (6) | 65 | 224 | 245 | 203 | 185 | 179 | 85 | 79 |

NOTES
(1) All examples (1 thru 8) are dilutions from concentrates to create the working solutions are described by Table 1 for testing.
(2) Chromium(III)-nitrate solution (11.5% CrIII) used as chromium source in all examples
(3) Sodium salts of NO₃⁻ and SO₄⁻² used in all examples.
(4) Cobalt(II)-sulfate heptahydrate used in all examples.
(5) Ammonium bifluoride used as F. source in examples.
(6) Fischer Scope X-RAY XAN

Multiple parts were produced and tested using each example. Parts were divided into two groups for salt spray testing. All salt spray tests were conducted by ASTM B-117 salt spray test procedures. Group 1 parts were salt spray tested as is, Group 2 parts were scribed with a razor blade, as hereinbefore described, and salt spray tested. Table 2 contains the results of the salt spray tests.

TABLE 2

| | | Hours to first |
|---|---|---|
| Examples | Groups | white corrosion |
| 1 | uncut | 72 |
| 1 | scribed | 30 |
| 2 | uncut | 264 |
| 2 | scribed | 216 |
| 3 | uncut | 312 |
| 3 | scribed | 250 |
| 4 | uncut | 264 |
| 4 | scribed | 216 |
| 5 | uncut | 288 |
| 5 | scribed | 250 |
| 6 | uncut | 216 |
| 6 | scribed | 168 |
| 7 | uncut | 72 |
| 7 | scribed | 36 |
| 8 | uncut | 96 |
| 8 | scribed | 36 |

It can be seen from the results of Table 2 that the salt spray protection afforded with samples containing the monocarboxylic acid is greatly improved. A visual inspection of the scratched area of the above described self healing test revealed that the onset of white corrosion when compared to a control was much delayed. Once the corrosion did occur, its spread along the scratched surface edges was greatly inhibited when compared to a control. The control showed the scratched area to be the first area attacked in the salt chamber and the first area to show while corrosion.

The following examples show the non-chelation properties of the monocarboxylic acids. In each case the working solutions, as stated in Table 1, were used as base solutions. For all samples (1 thru 8) a 1 ml sample of each working solution was taken and diluted to 900 ml with tap water and mixed thoroughly. With constant mixing this dilute solution was pH adjusted using 10% caustic soda to a pH between 9.5 and 10.2. The solution was then diluted to final volume of 1 liter. This solution was allowed to mix for 15-20 minutes then was gravity filtered through two 5-10 micron filter papers (Fisher P5) and the filtrate was collected. The theoretical chromium III ion values were calculated for each sample based on the chromium ion concentration in the working solution and the dilution factor. The filtrates were run via atomic absorption spectroscopy (Varian SpectrAA 220) for chromium ions and recorded in Table 3. The chelation percentages were calculated based on the recorded AA chromium ion value divided by the theoretical chromium ion value.

TABLE 3

| | | | Cr III ions | Chromium |
|---|---|---|---|---|
| | | Theoretical Cr | after pH | III |
| Examples | Carboxylic | III (ppm) after | adjust and | ion |
| (from Table 1) | Acid | dilutions | filtration | Chelation |
| 1 | none | 4.37 | none | 0% |
| | | | present | |
| 2 | propionic | 4.37 | none present | 0% |
| | acid | | | |
| 3 | acetic acid | 4.37 | none present | 0% |
| 4 | acetic acid | 4.37 | none present | 0% |
| 5 | propionic | 5.98 | none present | 0% |
| | acid | | | |
| 6 | acetic and | 4.37 | none present | 0% |
| | propionic | | | |
| | acid | | | |
| 7 | malonic acid | 4.37 | 4.26 | 97% |
| 8 | oxalic acid | 4.37 | 3.98 | 91% |

It is apparent from the results of Table 3 that the use of a monocarboxylic acid in the disclosed invention presents no apparent chelating properties with the chromium(III) ions while present together in solution. It is also apparent that the inclusion of dicarboxylic acids, such as oxalic and malonic acid, create undesired strong chromium(III)-chelates.

While it will be apparent that the preferred embodiments of the invention disclosed are represented by the prior examples, it will be appreciated that the invention is susceptible to modification, variation, and change without departing from the intended scope or fair meaning of the subjoined claims.

What is claimed is:

1. An aqueous acidic conversion solution, comprising:
from about 0.5 to about 130 g/L of said conversion solution of a chromium(III) ion;
from about 1 to about 100 g/L of said conversion solution of one or more of a non-halide salt anion;
from about 1 to about 35 g/L of said conversion solution of one or more mono carboxylic acids or a salt thereof having from 1 to about 10 carbon atoms;
optionally, from about 0.1 to about 10 g/L of said conversion solution of one or more non-chromium metal ions comprising Groups 1, 2, 4, 5, 6, 7, 8, 9, 10, 11, 12, 13, or 14, of the Period Table;
optionally from about 0.1 to about 30 g/L of said conversion solution of one or more halide ions;
said conversion solution being substantially free of any chromium(VI) compounds, and
wherein said conversion solution is substantially free of chromium(III) chelate.

2. An aqueous acidic conversion solution according to claim 1, the amount of any said chromium(VI) ion is 10 mg/L or less of said conversion solution, wherein said non halide salt anion comprises nitrate, sulfate, phosphate, diphosphate, triphosphate, or acetate, or combinations thereof;
wherein the pH of said conversion solution is from about 1.0 to about 4.5; and
wherein the amount of any chromium(III) chelate is about 0.25 moles or less per mole of chromium(III) ion.

3. An aqueous acidic conversion solution according to claim 2, wherein said chromium(III) ion is derived from chromium(III) nitrate, chromium(III) sulfate, chromium(III) halide, chromium(III) acetate, and chromium(III) phosphate, chromium(III) oxide, and chromium(III) alum, or a chromium(VI) compound reduced to a chromium(III) compound, wherein said chromium(VI) reduction compound is a chromium(VI) trioxide or a sodium dichromate compound, or combinations thereof; wherein the amount of said chromium(III) ion is from about 2.0 to about 50 g/L of said solution;
wherein said non-halide salt anion is derived from a nitrate, a sulfate, an acetate, or a phosphate salt of one or more of Groups 1, 2, and 4 through 13 of the Periodic Table, or an ammonium nitrate, an ammonium sulfate, or an ammonium phosphate salt, or combinations thereof;
wherein said optional non-chromium metal ion is derived from sodium, potassium, iron, cobalt, nickel, molybdenum, manganese, aluminum, lanthanum, cerium, zirconium, silver, silicon, copper, gallium, or titanium, or combinations thereof;
wherein said monocarboxylic acid has from 1 to about 5 carbon atoms and where the amount of said monocarboxylic acid is from about 2.0 to about 25 g/L of said conversion solution;
wherein said optional halide ion is fluoride, chloride, or bromide, or combinations thereof; and
wherein the amount of said chromium(VI) ion is 1 mg/L or less of said conversion solution; and
wherein the amount of any said chromium(III) chelate is about 0.10 moles or less per mole of chromium(III) ion.

4. An aqueous conversion solution according to claim 3, wherein the pH of said conversion solution is from about 1.8 to about 3.4;
wherein said chromium(III) ion is derived from chromium(III) chloride, chromium(ill) nitrite, chromium(III) sulfate, and chromium(III) acetate, or combinations thereof;
wherein said non-halide salt anion is derived from sodium nitrate, sodium sulfate, potassium nitrate, potassium sulfate, cobalt nitrate, cobalt sulfate, cobalt phosphate, sodium mono-, di-, or tri-phosphate, ammonium nitrate, ammonium sulfate, ammonium phosphate, nickel sulfate, nickel acetate, zirconyl nitrate, chromium(III) nitrate, chromium(III) acetate, chromium(III) sulfate, chromium(III) phosphate, or a chromium(III) halide, or combinations thereof, and wherein the amount of said non-halide salt anion is from about 5 to about 50 g/L of said conversion solution;
wherein said monocarboxylic acid is formic acid, acetic acid, or propionic acid, or combinations thereof, and wherein the amount of said monocarboxylic acid is from about 2.5 to about 20 g/L of said conversion solution;
including said non-chromium metal ion, wherein said metal ion is derived from sodium, potassium, iron, cobalt, nickel, molybdenum, vanadium, titanium, or zirconium, or combinations thereof, wherein the amount of said metal ion is from about 1 to about 7.5 g/L of said conversion solution; and
including said halide ion, wherein said halide ion is fluoride, or chloride, or both, wherein the amount of said fluoride ion is from about 0.5 to about 10 g/L of said conversion solution.

5. An aqueous acidic conversion solution according to claim 4, wherein the amount of said one or more chromium(III) ions is from about 3 to about 20 g/L of said conversion solution;
wherein the amount of said non-halide anion is from about 15 to about 40 g/L of said conversion solution;
wherein the amount of any said chromium(VI) ion is less than the detectable limit of GMW test 3034;
wherein the amount of any fluoride or chloride, or both, ion is from about 0.75 to about 5.0 g/L of said conversion solution; and
wherein the amount of any said chromium(III) chelate is about 0.05 moles or less per mole of chromium(III) ion.

6. A concentrated acidic conversion solution of claim 1, comprising from about 3 to about 30 times each of said amount of chromium(III) ion, said non-halide salt anion, said monocarboxylic acid, said non-chromium metal ion, and said halide ion.

7. A concentrated acidic conversion solution of claim 3, comprising from about 3 to about 30 times each of said amount of chromium(III) ion, said non-halide salt anion, said monocarboxylic acid, said non-chromium metal ion, and said halide ion.

8. A concentrated acidic conversion solution of claim 4, comprising from about 5 to about 20 times each of said amount of chromium(III) ion, said non-halide salt anion, said monocarboxylic acid, said non-chromium metal ion, and said halide ion.

9. The dry conversion layer of claim 1 located on a metal substrate.

10. The dry conversion layer of claim 4, located on a metal substrate.

11. The dry conversion layer of claim 1, located on a metal substrate, and wherein the thickness of said conversion layer is from about 60 to about 750 nanometers.

12. The dry conversion layer of claim 3, located on a metal substrate, and wherein the thickness of said conversion layer is from about 60 to about 750 nanometers.

13. The dry conversion layer of claim 4, located on a metal substrate, and wherein the thickness of said conversion layer is from about 80 to about 600 nanometers.

14. The dry conversion layer of claim 4, located on a metal substrate, and wherein the thickness of said conversion layer is from about 100 to about 500 nanometers.

15. The dry conversion layer of claim 9, wherein said substrate is a zinc, a zinc alloy, an aluminum, or an aluminum alloy.

16. The dry conversion layer of claim 11, wherein said substrate is a zinc, a zinc alloy, an aluminum, or an aluminum alloy.

17. The dry conversion layer of claim 12, wherein said substrate is zinc, or a zinc alloy.

18. The dry conversion layer of claim 14, wherein said substrate is zinc, or a zinc alloy.

19. The dry conversion layer of claim 9, wherein the onset of corrosion according to ASTM B-117 is at least about 80 hours.

20. The dry conversion layer of claim 11, wherein the onset of corrosion according to ASTM B-117 is at least about 120 hours.

21. The dry conversion layer of claim 14, wherein the onset of corrosion according to ASTM B-117 is at least about 180 hours.

22. The dry conversion layer of claim 15, wherein the onset of corrosion according to ASTM B-117 is at least about 80 hours.

23. The dry conversion layer of claim 17, wherein the onset of corrosion according to ASTM B-117 is at least about 120 hours.

24. The dry conversion layer of claim 18, wherein the onset of corrosion according to ASTM B-117 is at least about 180 hours.

25. An article comprising a coated metal substrate of claim 9.

26. An article comprising the coated metal substrate of claim 9, wherein said article is an automotive component, a barrel plated article, a rack plated article, a manufacturing or industrial component, or a consumer component.

27. An article according to claim 11, wherein said automotive component is a stamping; brake component comprising a brake line, caliper, pad, rotor, or hydraulic coupling; a transmission, engine, or steering component; a clip; a cylinder; a rivet; a fastener; or an oil filter housing;
wherein said barrel plated article is a fastener, washer, clamp, nut, stamping, bar steel, fitting, or spring;
wherein said a rack plated article is a computer chassis, refrigerator bracket or shelving, electrical motor mount, speaker grill, fastener or stamping, oil filter housing, spring, tubing, or clip;
wherein said general manufacturing or industrial component is an electrical box, motor housing, air conditioning guard, heat exchanger, small engine component, bracket, nail, garage door roller or pulley, or plumbing fastener or bracket; and
wherein said consumer component is a door hinge, refrigerator shelving, compressor component, fastener, shopping cart, lawn and garden tool or equipment, appliance clamp or stamping, door latch, audio or video component, furniture component, or drawer slide.

28. An article according to claim 14, wherein said automotive component is a stamping; brake component comprising a brake line, caliper, pad, rotor, or hydraulic coupling; a transmission, engine, or steering component; a clip; a cylinder; a rivet; a fastener; or an oil filter housing;
wherein said barrel plated article is a fastener, washer, clamp, nut, stamping, bar steel, fitting, or spring;
wherein said a rack plated article is a computer chassis, refrigerator bracket or shelving, electrical motor mount, speaker grill, fastener or stamping, oil filter housing, spring, tubing, or clip;
wherein said general manufacturing or industrial component is an electrical box, motor housing, air conditioning guard, heat exchanger, small engine component, bracket, nail, garage door roller or pulley, or plumbing fastener or bracket; and
wherein said consumer component is a door hinge, refrigerator shelving, compressor component, fastener, shopping cart, lawn and garden tool or equipment, appliance clamp or stamping, door latch, audio or video component, furniture component, or drawer slide.

29. An article according to claim 15, wherein said automotive component is a stamping; brake component comprising a brake line, caliper, pad, rotor, or hydraulic coupling; a transmission, engine, or steering component; a clip; a cylinder; a rivet; a fastener; or an oil filter housing;
wherein said barrel plated article is a fastener, washer, clamp, nut, stamping, bar steel, fitting, or spring;
wherein said a rack plated article is a computer chassis, refrigerator bracket or shelving, electrical motor mount, speaker grill, fastener or stamping, oil filter housing, spring, tubing, or clip;
wherein said general manufacturing or industrial component is an electrical box, motor housing, air conditioning guard, heat exchanger, small engine component, bracket, nail, garage door roller or pulley, or plumbing fastener or bracket; and
wherein said consumer component is a door hinge, refrigerator shelving, compressor component, fastener, shopping cart, lawn and garden tool or equipment, appliance clamp or stamping, door latch, audio or video component, furniture component, or drawer slide.

30. An article according to claim 16, wherein said automotive component is a stamping; brake component comprising a brake line, caliper, pad, rotor, or hydraulic coupling; a transmission, engine, or steering component; a clip; a cylinder; a rivet; a fastener; or an oil filter housing;
wherein said barrel plated article is a fastener, washer, clamp, nut, stamping, bar steel, fitting, or spring;
wherein said a rack plated article is a computer chassis, refrigerator bracket or shelving, electrical motor mount, speaker grill, fastener or stamping, oil filter housing, spring, tubing, or clip;
wherein said general manufacturing or industrial component is an electrical box, motor housing, air conditioning guard, heat exchanger, small engine component, bracket, nail, garage door roller or pulley, or plumbing fastener or bracket; and
wherein said consumer component is a door hinge, refrigerator shelving, compressor component, fastener, shopping cart, lawn and garden tool or equipment, appliance clamp or stamping, door latch, audio or video component, furniture component, or drawer slide.

31. An article according to claim 18, wherein said automotive component is a stamping; brake component comprising a brake line, caliper, pad, rotor, or hydraulic coupling; a transmission, engine, or steering component; a clip; a cylinder; a rivet; a fastener; or an oil filter housing;
wherein said barrel plated article is a fastener, washer, clamp, nut, stamping, bar steel, fitting, or spring;
wherein said a rack plated article is a computer chassis, refrigerator bracket or shelving, electrical motor mount, speaker grill, fastener or stamping, oil filter housing, spring, tubing, or clip;
wherein said general manufacturing or industrial component is an electrical box, motor housing, air conditioning guard, heat exchanger, small engine component, bracket, nail, garage door roller or pulley, or plumbing fastener or bracket; and
wherein said consumer component is a door hinge, refrigerator shelving, compressor component, fastener, shopping cart, lawn and garden tool or equipment, appliance clamp or stamping, door latch, audio or video component, furniture component, or drawer slide.

32. A process for applying a conversion layer to a metal substrate, comprising the steps of:
preparing a conversion solution comprising:
from about 0.5 to about 130 g/L of a chromium(III) ion;
from about 1.0 to about 100 g/L of said conversion solution of one or more of a salt non-halide anion;
from about 1 to about 35 g/L of said conversion solution of one or more mono carboxylic acids or a salt thereof having from 1 to about 10 carbon atoms;
optionally, from about 0.1 to about 10 g/L of said conversion solution of one or more non-chromium metal ions comprising Groups 1, 2, 4, 5, 6, 7, 8, 9, 10, 11, 12, 13, or 14, of the Period Table;
optionally from about 0.1 to about 30 g/L of said conversion solution of one or more halide ions;
said conversion solution being substantially free of any chromium(VI) compounds;
wherein said conversion solution is substantially free of chromium(III) chelate; and
applying said conversion solution to said metal substrate to form a treated article, and
wherein the corrosion resistance of said conversion layer in a salt spray according to ASTM B-117 to first white corrosion is at least about 80 hours.

33. The process of claim 32, wherein the amount of any said chromium(VI) ion is 10 mg/L or less of said conversion solution, wherein said non halide salt anion comprises nitrate, sulfate, phosphate, diphosphate, triphosphate, or acetate, or combinations thereof;
wherein the amount of any chromium(III) chelate is about 0.25 moles or less per mole of chromium(III) ion,
wherein the pH of said conversion solution is from about 1.0 to about 4.5; and
wherein said corrosion resistance of said conversion layer in a salt spray according to ASTM B-117 to first white corrosion is at least about 120 hours.

34. The process of claim 33, wherein said chromium(III) ion is derived from chromium(III) nitrate, chromium(III) sulfate, chromium(III) halide, chromium(III) acetate, and chromium(III) phosphate, chromium(III) oxide, and chromium(III) alum, or a chromium(VI) compound reduced to a chromium(III) compound, wherein said chromium(VI) reduction compound is a chromium(VI) trioxide or a sodium dichromate compound, or combinations thereof; wherein the amount of said chromium(III) ion is from about 2.0 to about 50 g/L of said solution;
wherein said non-halide salt anion is derived from a nitrate, a sulfate, an acetate, or a phosphate salt of one or more of Groups 1, 2, and 4 through 13 of the Periodic Table, or an ammonium nitrate, an ammonium sulfate, or an ammonium phosphate salt, or combinations thereof;
wherein said optional non-chromium metal ion is derived from sodium, potassium, iron, cobalt, nickel, molybdenum, manganese, aluminum, lanthanum, cerium, zirconium, silver, silicon, copper, gallium, or titanium, or combinations thereof;
wherein said monocarboxylic acid has from 1 to about 5 carbon atoms and where the amount of said monocarboxylic acid is from about 2.0 to about 25 g/L of said conversion solution;
wherein said optional halide ion is fluoride, chloride, or bromide, or combinations thereof; and
wherein the amount of said chromium(VI) ion is 1 mg/L or less of said conversion solution; and
wherein the amount of any said chromium(III) chelate is about 0.10 moles or less per mole of chromium(III) ion.

35. The process of claim 34, wherein the pH of said conversion solution is from about 1.8 to about 3.4;
wherein said chromium(III ion is derived from sodium nitrate, sodium sulfate, potassium nitrate, potassium sulfate, chromium(III) chloride, chromium(III) nitrite, chromium(III) sulfate, and chromium(III) acetate, or combinations thereof, wherein the amount of said chromium(III) ion is from about 3 to about 20 g/L of said conversion solution;
wherein said non-halide salt anion is derived from sodium nitrate, sodium sulfate, potassium nitrate, potassium sulfate, cobalt nitrate, cobalt sulfate, cobalt phosphate, sodium mono-, di-, or tri-phosphate, ammonium nitrate, ammonium sulfate, ammonium phosphate, nickel sulfate, nickel acetate, zirconyl nitrate, chromium(III) nitrate, chromium(III) acetate, chromium(III) sulfate, chromium(III) phosphate, or a chromium(III) halide, or combinations thereof, and wherein the amount of said non-halide salt anion is from about 5 to about 50 g/L of said conversion solution;
wherein said monocarboxylic acid is formic acid, acetic acid, or propionic acid, or combinations thereof, and wherein the amount of said monocarboxylic acid is from about 2.5 to about 20 g/L of said conversion solution;
including said non-chromium metal ion, wherein said metal ion is derived from sodium, potassium, iron, cobalt, nickel, molybdenum, vanadium, titanium, or zirconium, or combinations thereof, wherein the amount of said metal ion is from about 1 to about 7.5 g/L of said conversion solution; and
including said halide ion, wherein said halide ion is fluoride or chloride, or both, wherein the amount of said fluoride ion or chloride ion, or both is from about 0.75 to about 5 g/L of said conversion solution, wherein said corrosion resistance of said conversion layer in a salt spray according to ASTM B-117 to first white corrosion is at least about 180 hours.

36. The process of claim 33, wherein said conversion solution is applied to said metal substrate at a temperature of from about 40° F. to about 135° F., and wherein said conversion layer has a thickness of from about 60 to about 750 nanometers.

37. The process of claim 35, wherein said conversion solution is applied to said metal substrate at a temperature of from about 60° F. to about 104° F., and wherein said conversion layer has a thickness of from about 100 to about 500 nanometers.

38. The process of claim 33, wherein said substrate is zinc, a zinc alloy, aluminum, or an aluminum alloy, or combinations thereof.

39. The process of claim 35, wherein said substrate is zinc, a zinc alloy, aluminum, or an aluminum alloy, or combinations thereof.

40. The process of claim 36, wherein said substrate is zinc, or a zinc alloy.

41. The process of claim 37, wherein said substrate is zinc, or a zinc alloy.

42. A conversion layer, comprising:
chromium(III), said conversion layer being substantially free of chromium(VI) compounds, said conversion layer having about 0.25 moles or less of a chromium(III) chelate per mole of chromium(III) metal, said conversion layer having a thickness of from about 60 to about 750 nanometers and a corrosion resistance to salt spray according to ASTM B-117 to first white corrosion of at least about 80 hours.

43. A conversion layer according to claim 42, including a) at least one metal compound, said metal compound being a Group 1, 2, 4, 5, 6, 7, 8, 9, 10, 11, 12, 13, or 14 metal, or including b) at least one halide, or both a) and b); and
wherein the amount of any said chromium(VI) is about 0.01 μg/cm2 or less.

44. A conversion layer according to claim 43, wherein said non-chromium metal is sodium; potassium, iron, cobalt, nickel, molybdenum, vanadium, titanium, or zirconium, or combinations thereof, and wherein said halide is fluoride or chloride, or combinations thereof.

45. A conversion layer according to claim 43, wherein said conversion layer thickness is from about 80 to 600 nanometers and said corrosion resistance is at least about 120 hours.

46. A conversion layer according to claim 44, wherein said conversion layer thickness is from about 100 to 500 nanometers and said corrosion resistance is at least about 180 hours.

47. A conversion layer according to claim 42, wherein said conversion layer is located on a metal substrate.

48. A conversion layer according to claim 43, wherein said conversion layer is located on a metal substrate, and wherein said metal substrate is zinc, a zinc alloy, aluminum, or an aluminum alloy, or combinations thereof.

49. A conversion layer according to claim 44, wherein said conversion layer is located on a metal substrate, and wherein said metal substrate is zinc, a zinc alloy, aluminum, or an aluminum alloy, or combinations thereof.

50. A conversion layer according to claim 46, wherein said conversion layer is located on a metal substrate, and wherein said metal substrate is zinc or a zinc alloy.
